(19) United States
(12) Patent Application Publication
(10) Pub. No.: US 2014/0281866 A1
(43) Pub. Date: Sep. 18, 2014

(54) DISPLAY APPARATUS AND COMPUTER READABLE RECORDING MEDIUM FOR RECORDING CONTROL PROGRAM OF DISPLAY APPARATUS

(71) Applicant: KONICA MINOLTA, INC., Chiyoda-ku (JP)

(72) Inventors: Kazuhisa KISHIMOTO, Mitaka-shi (JP); Tetsuhiro SHIBATA, Hamamatsu-shi (JP); Keiichiro HYODO, Kokubunji-shi (JP); Masayuki INOUE, Hino-shi (JP)

(73) Assignee: KONICA MINOLTA, INC., Chiyoda-ku (JP)

(21) Appl. No.: 14/200,248

(22) Filed: Mar. 7, 2014

(30) Foreign Application Priority Data
Mar. 18, 2013 (JP) 2013-055717

(51) Int. Cl. G06F 17/24

(52) U.S. Cl. CPC G06F 17/24
USPC 715/211

(57) ABSTRACT

An electronic paper terminal as a display apparatus selects one drawing mode (for example, eraser mode) as a drawing mode when a handwriting image by a handwriting input function is drawn by a user. When a page image on a display panel enters a state in which a drawing effect by the one drawing mode cannot be obtained, the one drawing mode is changed to another drawing mode (for example, pencil mode) with a different drawing effect from that of the one drawing mode.

### CROSS-REFERENCE TO RELATED APPLICATION

This application is based on Japanese Patent Application No. 2013-055717 filed on Mar. 18, 2013, the contents of which are incorporated herein by reference.

### BACKGROUND

1. Technical Field

The present invention relates to a display apparatus having a handwriting input function, and a computer readable recording medium that records a control program of the display apparatus.

2. Description of Related Arts

In recent years, attention has focused on electronic paper which is a display apparatus having visibility and portability of the same level as a paper medium. Many of portable display apparatuses typified by electronic paper include a function (so-called handwriting input function) which further superimposes handwriting images by a user in a state in which an image such as a document or the like is displayed on a display panel and displays a result. Usually, the handwriting input function is executed by a drawing application installed in the display apparatus.

In a typical drawing application, by operating various pointing devices, types (for example, pencil, brush, eraser, etc.), sizes (for example, thin, medium, and thick letters), colors (for example, black, red, blue, and white), and the like of drawing cursors for inputting handwriting images can be freely changed. For example, in Japanese Unexamined Patent Application Publication No. 2003-196671, an electronic blackboard system which includes a function of changing a size of an eraser cursor for erasing a drawn image on a display panel or selecting a drawing type (for example, line/figure/text) to be erased by the eraser cursor has been disclosed. In addition, the system of Japanese Unexamined Patent Application Publication No. 2003-196671 includes a function of completely erasing the drawn image on the display panel by a wholly erasing button in addition to a function of partially erasing the drawn image on the display panel by the eraser cursor.

However, when the wholly erasing button is pressed during display of the eraser cursor in the above-described system, all of the drawn images on the display panel are completely erased, and therefore an object to be erased by the eraser cursor is not present on the display panel. Thus, a user cannot restart handwriting input: to the display panel unless he or she manually changes a drawing mode. For example, the user is forced to perform an operation of canceling the eraser cursor on the display panel and selecting a “pencil” mode, a “brush” mode, or the like again.

In the same manner, when the entire display panel is filled with the same color as a set color of a pencil cursor during display of the pencil cursor, the image cannot be changed anymore even though the handwriting input is executed on the display panel using the pencil cursor. Thus, the user is forced to perform an operation of newly selecting an “eraser” mode after canceling the “pencil” mode or changing the set color of the pencil cursor. In this way, in the conventional drawing application, there is a problem in that, when a display image is completely erased or completely filled, a user cannot immediately restart the handwriting input.

### SUMMARY

The present invention has been made in view of the above problem. Therefore, an object of the present invention is to provide a display apparatus in which a user can immediately restart handwriting input even when a display image is completely erased or completely filled, and a computer readable recording medium in which a control program of the display apparatus is recorded.

To achieve at least one of the abovementioned objects, a display apparatus reflecting one aspect of the present invention, includes a handwriting input function of displaying a handwriting image drawn on a screen by a user and includes a selection unit that selects one drawing mode as a drawing mode when the handwriting image is input by the user, and a change unit that changes the one drawing mode to another drawing mode having a different drawing effect from that of the one drawing mode when a display image on the screen enters a state in which a drawing effect by the one drawing mode cannot be obtained.

Preferably, the one drawing mode is an eraser mode for drawing a line drawing having the same color as a background image of the screen, and the change unit changes the eraser mode to the other drawing mode when the display image on the screen is the background image which does not include the handwriting image, after the handwriting input is executed by the eraser mode.

Preferably, the display apparatus further includes a screen erasing function of erasing the display image on the screen at once, and the change unit changes the eraser mode to the other drawing mode when the display image on the screen is the background image which does not include the handwriting image, after the screen erasing function is executed.

Preferably, the display apparatus further includes a page changeover function of changing a page of the display image on the screen, and the change unit changes the eraser mode to the other drawing mode when the display image on the screen is the background image which does not include the handwriting image, after the page changeover function is executed.

Preferably, the change unit that has changed the eraser mode to the other drawing mode further changes the other drawing mode to the eraser mode when the display image on the screen is changed to a page including the handwriting image, after the page changeover function is executed.

Preferably, the display image on the screen is at least a part of a plurality of page images constituting a single document, the display apparatus further includes a whole page erasing function of erasing the plurality of page images at once, and the change unit changes the eraser mode to the other drawing mode when the display image on the screen is the background image which does not include the handwriting image, after the whole page erasing function is executed.

Preferably, the display image on the screen is displayed based on any one of a plurality of pieces of document data each of which corresponds to a single document, the display apparatus further includes a whole data erasing function of erasing the plurality of pieces of document data at once, and the change unit changes the eraser mode to the other drawing mode when the display image on the screen is the background image which does not include the handwriting image, after the whole data erasing function is executed.

Preferably, the one drawing mode is a drawing mode for drawing a line drawing with a predetermined color, and the change unit changes the one drawing mode to the other drawing mode when the screen is filled with the predetermined color.

Preferably, the other drawing mode is a drawing mode for drawing a line drawing with a different color from the predetermined color.

Preferably, the other drawing mode is a drawing mode set as a default.

Preferably, the other drawing mode is a drawing mode designated in advance by the user.

Preferably, the other drawing mode is a drawing mode previously selected by the selection unit.

Preferably, when the screen enters the state in which the drawing effect by the one drawing mode cannot be obtained and the handwriting image by the one drawing mode is drawn on the screen in the state, the change unit changes the one drawing mode to the other drawing mode.

Preferably, the display apparatus further includes a reception unit that receives an instruction as to whether to permit the change from the one drawing mode to the other drawing mode. Here, the change unit may change the one drawing mode to the other drawing mode only when the instruction to permit the change is received by the reception unit.

Preferably, the display apparatus further includes a notification unit that notifies, when the one drawing mode is changed to the other drawing mode by the change unit, the user of the change from the one drawing mode to the other drawing mode.

Preferably, the display apparatus is electronic paper of an electrophoresis system.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a front view showing an appearance of a display apparatus according to an embodiment of the present invention.

FIG. 2 is a block diagram showing a system configuration of a display apparatus according to an embodiment of the present invention.

FIG. 3 is a cross-sectional view showing a configuration of a main portion of a display panel according to an embodiment of the present invention.

FIG. 4 is a schematic view showing an example of a mode selection GUI according to an embodiment of the present invention.

FIG. 5 is a schematic view showing an example of a mode selection GUI according to an embodiment of the present invention.

FIGS. 6A to 6E are schematic views showing an example of state transition of a page image according to an embodiment of the present invention.

FIGS. 7A to 7E are schematic views showing a modification example of the state transition of FIGS. 6A to 6E.

FIGS. 8A to 8E are schematic views showing another modification example of the state transition of FIGS. 6A to 6E.

FIGS. 9A to 9D are schematic views showing still another modification example of the state transition of FIGS. 6A to 6E.

FIGS. 10A to 10D are schematic views showing yet another modification example of the state transition of FIGS. 6A to 6E.

FIGS. 11A to 11D are schematic views showing a further another modification example of the state transition of FIGS. 6A to 6E.

FIGS. 12A to 12D are schematic views showing another example of state transition of a page image according to an embodiment of the present invention.

FIG. 13 is a schematic view showing an example of drawing mode setting information according to an embodiment of the present invention.

FIG. 14 is a schematic view showing an example of user designation mode information according to an embodiment of the present invention.

FIG. 15 is a flowchart showing a procedure of a mode change process according to an embodiment of the present invention.

FIG. 16 is a flowchart showing the procedure of the mode change process according to an embodiment of the present invention (continued in FIG. 15).

FIG. 17 is a flowchart showing a procedure of an alternative mode selection process (S113 of FIG. 15) according to an embodiment of the present invention.

### DETAILED DESCRIPTION

The embodiments of this invention will be described below with reference to the accompanying drawings. FIG. 1 is a front view showing an appearance of an electronic paper terminal 1 as a display apparatus according to an embodiment of the present invention, and FIG. 2 is a block diagram showing a system configuration of the electronic paper terminal 1. As shown in FIG. 1, the electronic paper terminal 1 includes a display panel 141 that displays various images, a touch panel 131 that is integrated with the display panel 141, a key switch 132 that is disposed in an outer peripheral portion of the display panel 141, and the like.

As shown in FIG. 2, the electronic paper terminal 1 includes a system control unit 11, a data storage unit 12, an operation unit 13, a display unit 14, a communication unit 15, a power supply state monitoring unit 16, a power supply unit 17, and the like. The respective units are mutually communicably connected via a bus.

The system control unit 11 is a central processing unit (CPU), and controls operations of the whole apparatus by executing a control program stored in the data storage unit 12 which will be described later. More specifically, the system control unit 11 controls operations such as transmitting/receiving data with an external device, storing/reading various data by the data storage unit 12, displaying a page image by the display unit 14, inputting an operation instruction through the operation unit 13, and the like. These operations may be executed by a dedicated hardware circuit in place of the CPU.

The data storage unit 12 is a storage area that stores a control program to be executed by the system control unit 11, image data to be displayed by the display unit 14, or the like. In particular, the data storage unit 12 includes a read only memory (ROM) that stores a control program, a random access memory (RAM) that temporarily stores various data as a working area of the CPU, and the like.

The operation unit 13 receives an operation instruction of a user concerning change in display contents of the display unit 14, change in system settings of the entire apparatus, or the like. In particular, the operation unit 13 includes the resistance film type or capacitance type touch panel 131 integrated with the display panel 141, the key switch 132 provided in the outer peripheral portion of the display panel 141, and the like. However, as the touch panel 131, other types of touch panels such as a matrix type touch panel, a surface acoustic wave type touch panel, an infrared type touch panel, an electromagnetic induction type touch panel, and the like may be used.

The display unit 14 includes the display panel 141 made of color electronic paper of an electrophoresis system, and displays an image based on image data within the data storage unit 12 on the display panel 141. The image data within the data storage unit 12 contains data concerning various types of images such as business documents and papers, graphics, photographs, and the like. The image displayed on the display panel 141 based on such image data is displayed in a background portion of a handwriting image (described later) by a user, and thus may be referred to as a “background image” as below. The background image may be simply a white paper image. In addition, irrespective of presence/absence of the handwriting image by the user, the image displayed on the display panel 141 may be simply referred to as a “display image”. When the display image has a plurality of display pages, each of the display pages may be referred to as a “page image”. In the following descriptions, the plurality of page images are grouped in a unit of “documents” (that is, the plurality of page images constitute a single document), and image data corresponding to each document is stored in the data storage unit 12 as “document data”.

FIG. 3 is a cross-sectional view showing a configuration of a main portion of the display panel 141. In FIG. 3, an upper side of FIG. 3 indicates a front side of the display panel 141, and a lower side of FIG. 3 indicates a rear side of the display panel 141. The display panel 141 is color electronic paper of an electrophoresis system using microcapsules of each color such as yellow (Y), magenta (M), and cyan (C). Here, the “electronic paper” refers to a display apparatus which requires power in rewriting of the display image but does not require power in maintaining of the display image. The display panel 141 according to the present embodiment may be electronic paper of an electrowetting system or an electronic powder material system.

As shown in FIG. 3, microcapsules a (Y, M, and C) of each color enclose a white pigment a1 which is negatively charged and pigments a2 (Y, M, and C) of each color which are positively charged, together with a transparent dispersion medium such as oil or the like. A surface layer b is a front substrate made of a transparent material such as polyethylene terephthalate (PET) film or the like, and a transparent electrode c made of a transparent conductive film such as indium tin oxide (ITO) or the like is disposed on a rear-face side of the front substrate. A support layer d is a rear substrate made of an insulating material such as a polyimide film or the like, and rear electrodes (segment electrode) e (Y, M, and C) made of a small metal plate corresponding to each of the microcapsules a (Y, M, and C) are disposed on a front-face side of the rear substrate.

Each of the microcapsules a (Y, M, and C) is disposed between a respective rear electrode e and the transparent electrode c, and each of the microcapsules a (Y, M, and C) is bonded Lo the respective rear electrode e (Y, M, and C) via an adhesive layer f. In this manner, an innumerable number of microcapsules a (Y, M, and C) which are two-dimensionally disposed in a space between the front substrate (surface layer b) and the rear substrate (support layer d) via two electrode plates c and e (Y, M, and C) forms a display area of the display panel 141.

A display principle of the display panel 141 having the above-described structure will be described below. First, when a positive potential is applied to the rear electrode c (Y) corresponding to the microcapsule a (Y) of a Y color, the white pigment a1 which is negatively charged is moved to the rear electrode e (Y) side and the pigment a2 (Y) of the Y color which is positively charged is moved to the transparent electrode c side. As a result, the microcapsule a (Y) of the Y color displays the Y color on a front surface of the display panel 141. In addition, when a negative potential is applied to the rear electrode e (Y) corresponding to the microcapsule a (Y) of the Y color, the pigment a2 (Y) of the Y color which is positively charged is moved to the rear electrode e (Y) side and the white pigment a1 which is negatively charged is moved to the transparent electrode c side. As a result, the microcapsule a (Y) of the Y color displays a white color on a front surface of the display panel 141.

In the same manner, the microcapsule a (M) of an M color displays the M color when a positive potential is applied to the rear electrode e (M) corresponding to the microcapsule a (M) of the M color, and displays a white color when a negative potential is applied. In addition, the microcapsule a (C) of a C color displays the C color when a positive potential is applied to the rear electrode e (C) corresponding to the microcapsule a (C) of the C color, and displays a white color when a negative potential is applied. The display unit 14 switches a display color of each of the microcapsules a (C, Y, and M) by controlling a potential of the respective rear electrode e (Y, M, and C). Thus, color-displaying by subtractive color mixture is achieved in the entire display panel 141. However, in the present embodiment, color-displaying by additive color mixture may be achieved using the microcapsules of each color of red (R), green (G), and blue (B).

Referring again to FIGS. 1 and 2, the communication unit 15 is a short-distance radio communication module, and performs transmission and reception of data with an external device according to the wireless communication standard such as Bluetooth (registered trademark), IEEE 802.11, HomeRF, IrDA, and the like. The power supply state monitoring unit 16 monitors a state of the power supply unit 17 of the electronic paper terminal 1, and transmits, to the system control unit 11, information about a power amount that can be supplied. The power supply unit 17 is a secondary battery which is excellent in portability such as alkaline storage batteries, lithium-ion batteries, and the like.

The electronic paper terminal 1 having the above-described configuration has a function of superimposing a handwriting image of a user drawn on the display panel 141 by a pen type input device P on a background image and displaying a result. This function is referred to as a “handwriting input function” as below. More specifically, the electronic paper terminal 1 recognizes a trajectory of a tip of the input device P by the touch panel 131 integrated with the display panel 141, and displays a handwriting image formed of a line drawing along the trajectory on the display panel 141. The handwriting input function according to the present embodiment is executed by a drawing application installed in the electronic paper terminal 1.

In addition, the handwriting input function according to the present embodiment includes a plurality of drawing modes having different drawing effects. The user can select any one drawing mode on a dedicated graphical user interface (GUI). Such GUI is referred to as a “mode selection GUI” as below. FIGS. 4 and 5 are schematic views showing an example of a mode selection GUI. As shown in FIGS. 4 and 5, a user can select any one of “pencil”, “brush”, “airbrush”, and “eraser” as a line type of the handwriting image to be displayed in the display panel 141.

Here, when “pencil” is selected and handwriting input is performed, a handwriting image composed of a line drawing with a constant width is displayed in the display panel 141 along handwriting of the handwriting input by the pencil. In the same manner, when “brush” is selected and handwriting input is performed, a handwriting image as if it was painted with a brush is displayed in the display panel 141 along handwriting of the handwriting input, and when “airbrush” is selected and handwriting input is performed, a handwriting image as if it was painted with an air brush is displayed in the display panel 141 along handwriting of the handwriting input. In addition, when “eraser” is selected and handwriting input is performed, a handwriting image composed of a line drawing having the same color as the background image is displayed in the display panel 141. Here, when the background image is a solid image having a single color, a handwriting image having the same single color as the background image is displayed along the handwriting input by the eraser, and when the background image is an image having a different color for each pixel, for example, a document image, a handwriting image having a color corresponding to each pixel of the background image is displayed along the handwriting input by the eraser. Thus, along the trajectory on the display panel 141, an existing handwriting image is partially erased, and the background image appears.

As shown in FIGS. 4 and 5, a user can select any one of “thin”, “medium”, and “thick” as a line width of the handwriting image displayed in the display panel 141. In addition, the user can select any one of “black”, “red”, and “blue” as a line color of the handwriting image displayed in the display panel 141. However, when a line type of the handwriting image is “eraser”, a line color of the eraser is fixed as “white”. In addition, “white” that is a setting value (setting name) of the line color of the eraser uses the name “white” in order to enable a user to easily imagine that the handwriting image is removed (background image is displayed) from the fact that generally there are many cases in which the background image is a white mono-color, and therefore a white line drawing is not always displayed when handwriting input by the eraser is performed. For example, in a case in which the background image is a blue image, when handwriting input by the eraser is performed, a blue line drawing is displayed along the trajectory (blue background image appears) even though the setting value of the line color of the eraser is “white”.

As described above, in the mode selection GUI, by selecting the line type (pencil, eraser, or the like) of the handwriting image and then further selecting “line width” and “line color”, it is possible to select any one drawing mode from the plurality of drawing modes having different drawing effects. That is, “drawing mode” according to the present embodiment refers to a combination of selection results of a plurality of setting items (that is, line type, line width, and line color). However, in the following descriptions, a drawing mode when “pencil” is selected as the line type is collectively referred to as “pencil mode”. For example, a drawing mode selected in FIG. 5 may be referred to as a pencil mode of “line width: thick” and “line color: black”. This is also applied to other line types.

In addition, the drawing application according to the present embodiment has a page changeover function, a screen erasing function, a filling function, a whole page erasing function, and a whole data erasing function in addition to the above-described handwriting input function. Here, the page changeover function is a function of changing a currently displayed page image to another page image. The page changeover function is executed when a page changeover button 131a on the touch panel 131 or a key switch 132 is pressed.

In addition, the screen erasing function is a function of erasing a handwriting image of a currently displayed page image at once. The screen erasing function is executed when a “filling/screen erasing” button 131b on the touch panel 131 is pressed in a state in which the eraser mode is selected. The filling function is a function of painting out a page image on the display panel 141 with a “line color” of a currently selected drawing mode. The filling function is executed when the “filling/screen erasing” button 131b on the touch panel 131 is pressed in a state in which a drawing mode other than the eraser mode is selected.

In addition, the whole page erasing function is a function of erasing not only a page image displayed on the display panel 141 but also all page images in a document to which the page image belongs at once. The whole page erasing function is executed when a “whole page erasing” button 131c on the touch panel 131 is pressed. When the whole page erasing function is executed, document data corresponding to a document to which the page image currently displayed on the display panel 141 belongs is erased, and therefore the page image currently displayed on the display panel 141 is changed to a white paper image.

The whole data erasing function is a function of erasing not only the document to which the page image currently displayed on the display panel 141 belongs but also all of the page images of all of documents which can be displayed on the display panel 141 at once. The whole data erasing function is executed when a “whole data erasing” button 131d on the touch panel 131 is pressed. When the whole data erasing function is executed, the whole document data within the data storage unit 12 is erased, and therefore the page image on the display panel 141 is changed to the white paper image.

Next, transition of a page image on the display panel 141 by the handwriting input function according to the present embodiment will be described. FIGS. 6A to 6E are schematic views showing an example of state transition of a page image on the display panel 141. In addition, in this example, it is assumed that the pencil mode of “line width: thick” and “line color: black” is selected in the mode selection GUI (see FIG. 5). In addition, it is assumed that a background image displayed on the display panel 141 is the white paper image.

First, as shown in FIG. 6A, when a handwriting image by the currently selected pencil mode is input, the handwriting image is displayed on the display panel 141. Next, when the eraser mode is selected on the mode selection GUI and handwriting input is performed as shown in FIG. 6B, a handwriting image by the currently selected eraser mode is further displayed on the display panel 141 as shown in FIG. 6C. Thus, the handwriting image by the pencil mode displayed in FIG. 6A is partially erased.

Next, as shown in FIG. 6D, when the “filling/screen erasing” button 131b is pressed, the handwriting images of the page image are erased at once, and therefore the page image is changed to the background image (white paper image). Thus, the page image on the display panel 141 is shifted to a state in which a drawing effect by the eraser mode cannot be obtained. “The state in which the drawing effect cannot be obtained” refers to a state in which the page image on the display panel 141 is not changed even though the handwriting image is input. Since the handwriting image is not included in the page image of FIG. 6D, the page image is in a state in which the page image is not changed even though the handwriting image by the eraser mode is input.

Therefore, the drawing application according to the present embodiment changes the currently selected eraser mode to another drawing mode having a different drawing effect from that of the currently selected eraser mode in order to eliminate the above-described state. In this manner, the currently selected drawing mode being automatically changed may be referred to as “automatic change” below. In an example of FIG. 6D, at the time of automatic change, a drawing mode (that is, pencil mode) selected immediately preceding the eraser mode is newly selected.

In addition, the drawing mode newly selected at the time of automatic change is not limited to the drawing mode selected immediately preceding the eraser mode, and may be a drawing mode (hereinafter, referred to as “default mode”) set as a default in the drawing application or a drawing mode (hereinafter, referred to as “user designation mode”) designated in advance by a user in the mode selection GUI or the like. In this manner, since the new drawing mode is automatically selected, a user can continue to input the handwriting image without manually changing the drawing mode.

In addition, an operation at the time of the above-described automatic change is determined in accordance with drawing mode setting information within the data storage unit 12. FIG. 13 is an example of drawing mode setting information according to the present embodiment. The drawing mode setting information according to the present example is composed of columns of “propriety of automatic change” and “operation after automatic change”, and “prohibited” or “permitted” is designated in the column of the “propriety of automatic change” (FIG. 13 shows that setting value in which a mark ‘O’ is described is designated, and “permitted” is designated in FIG. 13). Here, when “prohibited” is designated, the automatic change is prohibited, and when “permitted” is designated, the automatic change is permitted.

Next, in the column of “operation after automatic change”, any one of “default mode”, “user designation mode”, and “immediately preceding drawing mode” is designated (in FIG. 13, “default mode” is selected). Here, when the “default mode” is designated, the drawing mode is automatically changed to a drawing mode (the above-described default mode) which is set as a default in the drawing application at the time of automatic change. The default mode according to the present embodiment is preferably a drawing mode that is most frequently used by a user. As an example of the default mode, the pencil mode of “line width: thick” and “line color: black” may be used.

In addition, when the “user designation mode” is designated, the drawing mode is automatically changed to a drawing mode (the above-described user designation mode) which is designated in advance by a user, at the time of automatic change. The user designation mode according to the present embodiment is defined in the user designation mode information within the data storage unit 12. FIG. 14 is an example of user designation mode information according to the present embodiment. In FIG. 14, the mark ‘O’ is given in settings designated by a user. In the user designation mode information according to the present example, airbrush mode of “line width: thick” and “line color: blue” is defined as the user designation mode.

When the “immediately preceding drawing mode” is designated, the drawing mode is automatically changed to a drawing mode which is selected immediately preceding the drawing mode, at the time of automatic change (see FIG. 6D). Contents of the drawing mode setting information and the user designation mode information can be appropriately modified in the dedicated GUI (not shown).

Next, FIG. 6E shows a state in which a page image on the display panel 141 is changed from a page image (2/5 page) in which a handwriting image is wholly erased to a page image (1/5 page) including the handwriting image after the page changeover button 131a is pressed, and a state in which a drawing effect by the eraser mode cannot be obtained has been already eliminated. Then, the drawing application according to the present embodiment further changes the drawing mode (pencil mode) after the automatic change of FIG. 6D to the drawing mode (eraser mode) before the automatic change. Thus, the user can continue to input the handwriting image by the drawing mode (eraser mode) before the automatic change with respect to a new page image (1/5 page).

FIGS. 7A to 7E are schematic views showing a modification example of the state transition of FIGS. 6A to 6E. State transitions of FIGS. 7A to 7D are the same as FIGS. 6A to 6D which have been described above, and thus detailed description thereof will be omitted. FIG. 7E shows a state in which the page image on the display panel 141 is changed from the page image (2/5 page) in which the handwriting image is wholly erased to the following page image (3/5 page) after the page changeover button 131a is pressed. Here, it is assumed that the 3/5 page is a page image in which the handwriting image is not present. In this case, the page image on the display panel 141 remains as the background image (white paper image) (3/5 page) even though change of the page image is performed. Therefore, in FIG. 7E, the drawing mode (pencil mode) after the automatic change is maintained as is.

FIGS. 8A to 8E are schematic views showing another modification example of the state transition of FIGS. 6A to 6E. State transitions of FIGS. 8A to 8C are the same as FIGS. 6A to 6C which have been described above, and thus detailed description thereof will be omitted. In FIG. 8D, as a result of pressing the “filling/screen erasing” button 131b, the page image is changed to the background image (white paper image), but the automatic change is not immediately executed as shown in FIG. 6D. Alternatively, in the present example, when the handwriting image is input to the display panel 141 again, the automatic change is executed (see FIG. 8E). In addition, in FIG. 8E, a message informing a user that the automatic change is executed by the drawing application is displayed.

FIGS. 9A to 9D are schematic views showing still another modification example of the state transition of FIGS. 6A to 6E. State transitions of FIGS. 9A to 9C are the same as FIGS. 6A to 6C which have been described above, and thus detailed description thereof will be omitted. In FIG. 9D, as a result of handwriting input by the “eraser mode”, the page image on the display panel 141 is completely erased and changed to the background image (white paper image). Thus, the page image on the display panel 141 is shifted to a state in which a drawing effect by the eraser mode cannot be obtained, and therefore the automatic change of the drawing mode by the drawing application is executed in the same manner as in FIG. 6D.

FIGS. 10A to 10D are schematic views showing yet another modification example of the state transition of FIGS. 6A to 6E. State transitions of FIGS. 10A to 100 are the same as FIGS. 6A to 6C which have been described above, and thus detailed description thereof will be omitted. As shown in FIG. 10D, when the “whole page erasing” button 131c is pressed, all of the page images of a document to which the page image on the display panel 141 belongs are erased at once, and therefore the page image on the display panel 141 is changed to the white paper image. Thus, the page image is shifted to a state in which a drawing effect by the eraser mode cannot be obtained, and therefore the automatic change of the drawing mode by the drawing application is executed in the same manner as in FIG. 6D. In addition, state transition when the “whole data erasing” button 131d rather than the “whole page erasing” button 131c is pressed is also the same as in FIGS. 10A to 10D which have been described above.

FIGS. 11A to 11D are schematic views showing a further another modification example of the state transition of FIGS. 6A to 6E. State transitions of FIGS. 11A to 11C are the same as FIGS. 6A to 6C which have been described above, and thus detailed description thereof will be omitted. In FIG. 11D, as a result of pressing the page changeover button 131a, the page image on the display panel 141 is changed from a page image (2/5 page) in which a handwriting image is displayed to a page image (3/5 page) of a background image (white paper image) which does not include the handwriting image. Thus, the page image on the display panel 141 is shifted to a state in which a drawing effect by the eraser mode cannot be obtained, and therefore automatic change of the drawing mode by the drawing application is executed in the same manner as in FIG. 6D.

Next, FIGS. 12A to 12D are schematic views showing another example of state transition of a page image on the display panel 141. First, as shown in FIG. 12A, the pencil mode of “line width: thick” and “line color: red” is selected in the mode selection GUI. Next, as shown in FIG. 12B, when the “filling/screen erasing” button 131b is pressed, the page image on the display panel 141 is filled with “line color: red”. The page image of FIG. 12B is not changed even though a handwriting image by the pencil mode of “line width: thick” and “line color: red” is input, and therefore the page image is shifted to a state in which a drawing effect by the currently selected drawing mode cannot be obtained.

Therefore, the drawing application according to the present embodiment executes automatic change of the drawing mode in order to eliminate the above-described state (see FIG. 12C). More specifically, in FIG. 12C, the pencil mode of “line width: thick” and “line color: red” is changed to the pencil mode of “line width: thick” and “line color: black”. As shown in FIG. 12D, a user can confirm execution of the automatic change on the mode selection GUI. In this manner, a new drawing mode is automatically selected, and therefore the user can continue to input the handwriting image without manually changing the drawing mode. In addition, the same message as in FIG. 8E is displayed, and therefore the user can confirm the drawing mode after the automatic change without opening the mode selection GUI.

Next, outlines of operations of the electronic paper terminal 1 according to the present embodiment will be described. FIGS. 15 and 16 are flowcharts showing procedures of processes in accordance with automatic change of the drawing mode. The process in accordance with the automatic change of the drawing mode may be referred to as “drawing mode changing process” below. An algorithm shown by the flowcharts of FIGS. 15 and 16 is stored in a ROM of the data storage unit 12 as a control program, and the control program is executed by the system control unit 11 (CPU), and therefore the processes shown in FIGS. 15 and 16 are realized.

As shown in FIG. 15, first, the system control unit 11 that executes the drawing application determines whether “prohibited” is designated in the column of “propriety automatic change” (see FIG. 13) of the above-described drawing mode setting information (S101). Here, when the “prohibited” is designated (YES in S101), the drawing mode changing process is completed (end) as is. In contrast, when the “prohibited” is not designated (NO in S101), that is, when “permitted” is designated, the drawing mode changing process proceeds to S102 which will be described later.

Next, in S102, whether a drawing mode which is currently selected is the eraser mode is determined. Next, when the currently selected drawing mode is the eraser mode (YES of S102), whether the “whole data erasing” button 131d, the “whole page erasing” button 131c, or the “filling/screen erasing” button 131b on the touch panel 131 is pressed is determined (S103 to S105). On the other hand, when the currently selected drawing mode is not the eraser mode (NO in S102), the process proceeds to S114 which will be described later (see FIG. 16).

Here, when the “whole data erasing” button 131d on the touch panel 131 is pressed (YES in S103), the entire image data within the data storage unit 12 is erased (S109), and then the process proceeds to S112 which will be described later. In this instance, the page image on the display panel 141 is shifted to a state in which a drawing effect by the currently selected eraser mode cannot be obtained. In addition, when the “whole page erasing” button 131c on the touch panel 131 is pressed (NO in S103 and YES in S104), all of the page images is erased (S110), and then the process proceeds to S112 which will be described later. In this instance, the page image on the display panel 141 is shifted to the state in which the drawing effect by the currently selected eraser mode cannot be obtained. In addition, when the “filling/screen erasing” button 131b on the touch panel 131 is pressed (NO in S103, NO in S104, and YES in S105), a handwriting image of the page image is erased (S111), and then the process proceeds to S112 which will be described later. In this instance, the page image on the display panel 141 is shifted to the state in which the drawing effect by the currently selected eraser mode cannot be obtained.

On the other hand, when any one of the “whole data erasing” button 131d, the “whole page erasing” button 131c, and the “filling/screen erasing” button 131b on the touch panel 131 is not pressed (NO in S103, NO in S104, and NO in S105), whether the handwriting image of the page image is completely erased after handwriting input by the eraser mode is determined (S106). Next, when the handwriting image of the page image is completely erased (YES in S106), the process proceeds to S112, which will be described later. In this instance, the page image on the display panel 141 is shifted to the state in which the drawing effect by the currently selected eraser mode cannot be obtained.

On the other hand, when the handwriting image of the page image is not completely erased (NO in S106), whether the “page changeover” button 131a on the touch panel 131 is pressed is determined (S107). Here, when the “page changeover” button 131a is not pressed (NO in S107), the drawing mode changing process is completed (end) as is, and when the “page changeover” button 131a is pressed (YES in S107), whether a new page image is the background image (white paper image) is determined (S108). Next, when the new page image is not the white paper image (NO in S108), the drawing mode changing process is completed (end) as is, and when the new page image is the white paper image (YES in S108), the process proceeds to S112 which will be described later. In the latter case, the page image on the display panel 141 is shifted to the state in which the drawing effect by the currently selected eraser mode cannot be obtained.

In S112, the currently selected eraser mode is canceled. The term “cancel” means that the currently selected drawing mode is temporarily invalidated. In this instance, information indicating that the eraser mode is canceled is stored in the data storage unit 12. Such information may be referred to as “eraser cancellation information” as below. Thereafter, another drawing mode instead of the drawing mode canceled in S112 is selected (S113), and then the drawing mode changing process is completed (end). The procedure of S113 is particularly referred to as an “alternative mode selection process”. Specific procedure of the alternative mode selection process (S113) will be described later.

As shown in FIG. 16, when the currently selected drawing mode is not the eraser mode in S102, the process proceeds to S114 as described above. In S114, whether the above-described eraser cancellation information is stored in the data storage unit 12 is determined. Here, when the eraser cancellation information is not stored in the data storage unit 12 (NO in S114), whether the “filling/screen erasing” button 131b on the touch panel 131 is pressed is determined (S115). Next, when the “filling/screen erasing” button 131b is pressed (YES in S115), the page image is filled with the “line color” which is currently selected (S116), and then the process proceeds to S117 which will be described later. When the “filling/screen erasing” button 131b is not pressed (NO in S115), the drawing mode changing process is completed (end) as is. In the former case, that is, when the page image is filled with the “line color” which is currently selected, the page image on the display panel 141 is shifted to the state in which the drawing effect by the currently selected drawing mode (other than the eraser mode) cannot be obtained. Thus, in S117, the currently selected drawing mode (other than the eraser mode) is canceled in order to eliminate the above-described state. Thereafter, the alternative mode selection process (S113) is executed, and then the mode changing process is completed (see FIG. 15).

On the other hand, when the eraser cancellation information is stored in the data storage unit 12 (YES of S114), whether the “page changeover” button 131a on the touch panel 131 is pressed is determined (S118). Next, when the “page changeover” button 131a is pressed (YES in S118), whether a new page image is the background image (white paper image) is determined (S119), and when the “page changeover” button 131a is not pressed (NO in S118), the process proceeds to S120.

In S119, when the new page image is the white paper image (YES in S119), the eraser cancellation information within the data storage unit 12 is erased (S122), and then the process proceeds to S115 which has been described above. On the other hand, when the new page image is not the white paper image (NO in S119), the state in which the drawing effect by the eraser mode cannot be obtained is eliminated, and therefore the currently selected drawing mode (other than the eraser mode) is changed to the eraser mode (S120). Thereafter, the eraser cancellation information within the data storage unit 12 is erased (S121), and then the mode changing process is completed (see FIG. 15).

FIG. 17 is a flowchart showing a procedure of an alternative mode selection process (S113) according to the present embodiment. First, the system control unit 11 that executes the drawing application determines whether the “default mode” or the “user designation mode” is designated in the column of “operation after automatic change” of the above-described drawing mode setting information (see FIG. 13) (S201 and S202).

Here, when the “default mode” is designated (YES in S201), the system control unit 11 selects the above-described default mode (for example, pencil mode of “line width: thin” and “line color: black”) (S204), and then the process returns to the drawing mode changing process of FIGS. 15 and 16 (return). In addition, when the “user designation mode” is designated (NO in S201 and YES in S202), the system control unit 11 selects the drawing mode (for example, airbrush mode of “line width: thick” and “line color: blue”) designated in the above-described user designation mode information (see FIG. 14) (S205), and then the process returns to the drawing mode changing process of FIGS. 15 and 16 (return).

On the other hand, when the “immediately preceding drawing mode” is designated in the column of “operation after automatic change” of the above-described user designation mode information (NO in S201 and NO in S202), the system control unit 11 selects again the drawing mode selected previous to the drawing mode canceled in S112 or S117 which has been described above (S203), and then the process returns to the drawing mode changing process of FIGS. 15 and 16 (return).

As described above, according to the drawing application according to the present embodiment, when the page image on the display panel 141 is shifted to the state in which the drawing effect by the currently selected drawing mode cannot be obtained, the drawing mode is automatically changed to another drawing mode having a different drawing effect from that of the currently selected drawing mode. Thus, according to the drawing application according to the present embodiment, even when the page image on the display panel 141 is completely erased or when the page image on the display panel 141 is completely filled, a user can immediately restart the handwriting input.

In addition, in the above-described embodiment, the operation unit 13 of the electronic paper terminal 1 acts as a selection unit that selects one drawing mode as a drawing mode when the handwriting image is input by a user, and a reception unit that receives an instruction as to whether to permit the change from the one drawing mode to another drawing mode. In addition, the system control unit 11 acts as a change unit that changes the one drawing mode to the other drawing mode having the different drawing effect from that of the one drawing mode when the display image on the screen is in a state in which the drawing effect by the one drawing mode cannot be obtained. The display unit 14 acts as a notification unit that notifies, when the one drawing mode is changed to the other drawing mode, the user of the change from the one drawing mode to the other drawing mode.

The present invention is not limited to the above-described embodiments, and may be modified in various ways within the scope of the appended claims. For example, the display apparatus according to the present invention is not limited to the electronic paper terminal, and any display terminal may be used as long as it has a handwriting input function to the display panel. For example, as the display apparatus according to the present invention, even a display unit of a terminal device such as a desktop PC, a tablet PC, a smart phone, and the like may be used. In addition, a type, a drawing effect, and the like of the drawing mode of the handwriting input function according to the present invention are not limited to those exemplified in the above-described embodiments.

In the above-described embodiments, the control method of the drawing mode when a user directly draws the input image on the touch panel has been described, but the control method of the drawing mode according to the present invention can be applicable to the control method of the drawing mode when the user draws the input image using other input devices such as a mouse, a touch pad, a pen tablet, and the like. In addition, according to the present invention, a combination of at least two control methods of the control methods illustrated in FIGS. 6 to 12 can be executed in a single display apparatus. However, such combination is not exclusive, and even when any combination is adopted in the single display apparatus, other combinations are not excluded in the display apparatus.

Units and methods for executing various processes in the display apparatus according to the present embodiments can be implemented by either one of a dedicated hardware circuit or a program executed on a computer. The above-described program may be provided by a computer readable recording medium such as a flexible disk or CD-ROM, or on-line via a network such as the Internet. In the former case, the program recorded in the computer readable recording medium is normally transmitted to a nonvolatile memory such as electronically erasable programmable read-only memory (EEPROM), hard disk drive (HDD), or the like.

What is claimed is:

1. A display apparatus which includes a handwriting input function of displaying a handwriting image drawn on a screen by a user, comprising:
a selection unit that selects one drawing mode as a drawing mode when the handwriting image is input by the user; and
a change unit that changes the one drawing mode to another drawing mode having a different drawing effect from that of the one drawing mode when a display image on the screen enters a state in which a drawing effect by the one drawing mode cannot be obtained.

2. The display apparatus as claimed in claim 1, wherein the one drawing mode is an eraser mode for drawing a line drawing having the same color as a background image of the screen, and
the change unit changes the eraser mode to the other drawing mode when the display image on the screen is the background image which does not include the handwriting image, after the handwriting input is executed by the eraser mode.

3. The display apparatus as claimed in claim 2, wherein the display apparatus further includes a screen erasing function of erasing the display image on the screen at once, and
the change unit changes the eraser mode to the other drawing mode when the display image on the screen is the background image which does not include the handwriting image, after the screen erasing function is executed.

4. The display apparatus as claimed in claim 2, wherein the display apparatus further includes a page changeover function of changing a page of the display image on the screen, and
the change unit changes the eraser mode to the other drawing mode when the display image on the screen is the background image which does not include the handwriting image, after the page changeover function is executed.

5. The display apparatus as claimed in claim 4, wherein the change unit that has changed the eraser mode to the other drawing mode further changes the other drawing mode to the eraser mode when the display image on the screen is changed to a page including the handwriting image, after the page changeover function is executed.

6. The display apparatus as claimed in claim 2, wherein the display image on the screen is at least a part of a plurality of page images constituting a single document,
the display apparatus further includes a whole page erasing function of erasing the plurality of page images at once, and
the change unit changes the eraser mode to the other drawing mode when the display image on the screen is the background image which does not include the handwriting image, after the whole page erasing function is executed.

7. The display apparatus as claimed in claim 2, wherein the display image on the screen is displayed based on any one of a plurality of pieces of document data each of which corresponds to a single document,
the display apparatus further includes a whole data erasing function of erasing the plurality of pieces of document data at once, and
the change unit changes the eraser mode to the other drawing mode when the display image on the screen is the background image which does not include the handwriting image, after the whole data erasing function is executed.

8. The display apparatus as claimed in claim 1, wherein the one drawing mode is a drawing mode for drawing a line drawing with a predetermined color, and
the change unit changes the one drawing mode to the other drawing mode when the screen is filled with the predetermined color.

9. The display apparatus as claimed in claim 8, wherein the other drawing mode is a drawing mode for drawing a line drawing with a different color from the predetermined color.

10. The display apparatus as claimed in claim 1, wherein the other drawing mode is a drawing mode set as a default.

11. The display apparatus as claimed in claim 1, wherein the other drawing mode is a drawing mode designated in advance by the user.

12. The display apparatus as claimed in claim 1, wherein the other drawing mode is a drawing mode previously selected by the selection unit.

13. The display apparatus as claimed in claim 1, wherein, when the screen enters the state in which the drawing effect by the one drawing mode cannot be obtained and the handwriting image by the one drawing mode is drawn on the screen in the state, the change unit changes the one drawing mode to the other drawing mode.

14. The display apparatus as claimed in claim 1, further comprising:
a reception unit that receives an instruction as to whether to permit the change from the one drawing mode to the other drawing mode,
wherein the change unit changes the one drawing mode to the other drawing mode only when the instruction to permit the change is received by the reception unit.

15. The display apparatus as claimed in claim 1, further comprising:
a notification unit that notifies, when the one drawing mode is changed to the other drawing mode by the change unit, the user of the change from the one drawing mode to the other drawing mode.

16. The display apparatus as claimed in claim 1, wherein the display apparatus is electronic paper of an electrophoresis system.

17. A non-transitory computer readable recording medium stored with a control program of a display apparatus which includes a handwriting input function of displaying a handwriting image drawn on a screen by a user, the program causing the display apparatus to execute a process comprising the steps of:
(A) selecting one drawing mode as a drawing mode when the handwriting image is input by the user; and
(B) changing the one drawing mode to another drawing mode having a different drawing effect from that of the one drawing mode when a display image on the screen enters a state in which a drawing effect by the one drawing mode cannot be obtained.

18. The non-transitory computer readable recording medium as claimed in claim 17, wherein the one drawing mode is an eraser mode for drawing a line drawing having the same color as a background image of the screen, and
in the step (B), the eraser mode is changed to the other drawing mode when the display image on the screen is the background image which does not include the handwriting image, after the handwriting input is executed by the eraser mode.

19. The non-transitory computer readable recording medium as claimed in claim 18, wherein the display apparatus further includes a screen erasing function of erasing the display image on the screen at once, and
in the step (B), the eraser mode is changed to the other drawing mode when the display image on the screen is the background image which does not include the handwriting image, after the screen erasing function is executed.

20. The non-transitory computer readable recording medium as claimed in claim 18, wherein the display apparatus further includes a page changeover function of changing a page of the display image on the screen, and
in the step (B), the eraser mode is changed to the other drawing mode when the display image on the screen is the background image which does not include the handwriting image, after the page changeover function is executed.

21. The non-transitory computer readable recording medium as claimed in claim 20, wherein the process further comprises a step of:
(C) further changing the other drawing mode to the eraser mode when the display image on the screen is changed to a page including the handwriting image, after the step (B) is executed and then the page changeover function is executed.

22. The non-transitory computer readable recording medium as claimed in claim 18, wherein the display image on the screen is at least a part of a plurality of page images constituting a single document,
the display apparatus further includes a whole page erasing function of erasing the plurality of page images at once, and
in the step (B), the eraser mode is changed to the other drawing mode when the display image on the screen is the background image which does not include the handwriting image, after the whole page erasing function is executed.

23. The non-transitory computer readable recording medium as claimed in claim 18, wherein the display image on the screen is displayed based on any one of a plurality of pieces of document data each of which corresponds to a single document,
the display apparatus further includes a whole data erasing function of erasing the plurality of pieces of document data at once, and
in the step (B), the eraser mode is changed to the other drawing mode when the display image on the screen is the background image which does not include the handwriting image, after the whole data erasing function is executed.

24. The non-transitory computer readable recording medium as claimed in claim 17, wherein the one drawing mode is a drawing mode for drawing a line drawing with a predetermined color, and
in the step (B), the one drawing mode is changed to the other drawing mode when the screen is filled with the predetermined color.

25. The non-transitory computer readable recording medium as claimed in claim 24, wherein the other drawing mode is a drawing mode for drawing a line drawing with a different color from the predetermined color.

26. The non-transitory computer readable recording medium as claimed in claim 17, wherein the other drawing mode is a drawing mode set as a default.

27. The non-transitory computer readable recording medium as claimed in claim 17, wherein the other drawing mode is a drawing mode designated in advance by the user.

28. The non-transitory computer readable recording medium as claimed in claim 17, wherein the other drawing mode is a drawing mode selected immediately preceding the one drawing mode.

29. The non-transitory computer readable recording medium as claimed in claim 17, wherein, in the step (B), when the screen enters the state in which the drawing effect by the one drawing mode cannot be obtained and the handwriting image by the one drawing mode is drawn on the screen in the state, the one drawing mode is changed to the other drawing mode.

30. The non-transitory computer readable recording medium as claimed in claim 17, wherein the process further comprises a step of:
(D) receiving an instruction as to whether to permit the change from the one drawing mode to the other drawing mode,
wherein in the step (B), the one drawing mode is changed to the other drawing mode only when the instruction to permit the change is received in the step (D).

31. The non-transitory computer readable recording medium as claimed in claim 17, wherein the process further comprises a step of:
(E) notifying, when the one drawing mode is changed to the other drawing mode in the step (B), the user of the change from the one drawing mode to the other drawing mode.

32. The non-transitory computer readable recording medium as claimed in claim 17, wherein the display apparatus is electronic paper of an electrophoresis system.
